(19) United States
(12) Patent Application Publication
(10) Pub. No.: US 2026/0123783 A1
(43) Pub. Date: May 7, 2026

(54) STEM REMOVER

(71) Applicant: Kitchendao Kitchenware Co., Ltd., YangJiang (CN)

(72) Inventors: Yuhong LIU, YangJiang (CN); Haisheng CHEN, YangJiang (CN); Jing HUANG, YangJiang (CN)

(73) Assignee: Kitchendao Kitchenware Co., Ltd., YangJiang (CN)

(21) Appl. No.: 19/374,587

(22) Filed: Oct. 30, 2025

(30) Foreign Application Priority Data
Nov. 1, 2024 (CN) 202422670925.9

(51) Int. Cl. A47J 21/00

(52) U.S. Cl. CPC A47J 21/00

(57) ABSTRACT

The present application relates to the technical field of stem-removing tools, and more particularly, to a stem remover. The stem remover includes a first clamp body, a second clamp body and a pin shaft. The first clamp body is rotatably connected to the second clamp body through the pin shaft. The stem remover further includes a locking structure movably mounted on the first clamp body and/or the second clamp body.

### CROSS-REFERENCE TO RELATED APPLICATION(S)

This application claims priority to Chinese Patent Application No. 202422670925.9 filed with the China National Intellectual Property Administration (CNIPA) on Nov. 1, 2024, the disclosure of which is incorporated herein by reference in its entirety.

### TECHNICAL FIELD

The present application relates to the technical field of stem-removing tools, and more particularly, to a stem remover.

### BACKGROUND

Stem-removing tools are used to remove the stems from vegetables or fruits, to prevent direct contact between nails and the interior of vegetables or fruits, which not only enhances hygiene to a certain extent and protects the nails, but also makes the appearance of the vegetables and fruits after stem removal relatively beautiful, and even improves the efficiency of stem removal.

Existing stem removers usually do not have the locking function and remain in a normally open state, which not only poses a safety hazard but also is unfavorable for storage.

### SUMMARY

The objective of the present application is to overcome the problems of safety hazards and inconvenient storage caused by the lack of a locking function in existing stem removers, and to provide a stem remover that may be locked in a closed state when not in use. This not only improves the safety factor but also saves storage space and enhances the convenience of storage.

In order to achieve the above objective, the technical solutions adopted by the present application are as follows.

A stem remover is provided. The stem remover includes a first clamp body, a second clamp body and a pin shaft. The first clamp body is rotatably connected to the second clamp body through the pin shaft. The stem remover further includes a locking structure movably mounted on the first clamp body and/or the second clamp body.

The stem remover in the present application achieves the stem-removing function in a manner of clamping the root and stem parts of fruits and vegetables by using the end of the first clamp body and the end of the second clamp body, and then pulling them out. The first clamp body is rotatably connected to the second clamp body through the pin shaft, thereby facilitating the adjustment of the distance between the two clamp bodies, and thus facilitating stem removal after an acting force is exerted on the root and stem. Compared with the stem remover in the related art, the stem remover of the present application adds a function of locking when the stem remover is in a closed state, which is achieved specifically through the locking structure. When locked, the first clamp body and the second clamp body cannot be opened, so the first clamp body and the second clamp body may be maintained in a locked state when closed. When unlocked, the first clamp body and the second clamp body may be freely opened or closed. The locking structure can also achieve the locking and unlocking functions of the first clamp body and the second clamp body in other manners.

Further, the locking structure includes a locking plate and a torsion spring, the torsion spring is sleeved on the pin shaft, two ends of the torsion spring abut against opposite inner sides of the first clamp body and the second clamp body, respectively, the locking plate is located between the first clamp body and the second clamp body and is provided with a movable hole penetrating through the locking plate, the pin shaft is located in the movable hole, two ends of the pin shaft are disposed to protrude beyond the locking plate, and the locking plate is movable back and forth relative to the pin shaft. In a locked state, the torsion spring is compressed, the locking plate is located at a first position and forms a rotation limit for the first clamp body and the second clamp body, and the first clamp body and the second clamp body are kept closed. In an unlocked state, the locking plate is located at a second position, and the torsion spring may push the first clamp body and the second clamp body to open outwards. The cooperation between the locking plate and the torsion spring enables the locking or unlocking of the first clamp body and the second clamp body. In one or more embodiments, the torsion spring is mounted on the pin shaft. When the stem remover is in the closed state, that is, the first clamp body and the second clamp body are closed, the torsion spring is in a stressed and compressed state. In this case, if the locking plate is located at the first position, since the first clamp body and the second clamp body are limited by the locking plate and no rotation space exists, then the stem remover is locked, and the first clamp body and the second clamp body are kept closed. Instead, if the locking plate is located at the second position, an avoidance is formed for rotating ends of the first clamp body and the second clamp body, and a rotatable space exists between the first clamp body and the second clamp body, then under the drive of the elastic restoring force of the torsion spring, the first clamp body and the second clamp body move away from each other, the stem remover is opened, and thus a normal stem removal operation may be performed. Since the position of the pin shaft remains fixed, the stem remover pushes the locking plate to move the movable hole relative to the pin shaft, thereby changing the position of the locking plate relative to the pin shaft. This enables an end where the first clamp body is rotatably connected to the second clamp body to be either limited or provided with a rotation space, thereby allowing the stem remover to flexibly switch between the locked state and the unlocked state. The stem remover is locked in the closed state when not in use, which can not only improve the safety factor but also save storage space and enhance the convenience of storage.

Further, the locking plate includes a locking portion and an unlocking portion connected to each other, an outer diameter of the locking portion is greater than an outer diameter of the unlocking portion, and the movable hole is located in the locking portion and/or the unlocking portion and includes a locking hole and an unlocking hole communicating with each other. In a case where the locking plate is located at the first position, the pin shaft is located in the locking hole, and the locking portion is located at the end where the first clamp body is rotatably connected to the second clamp body. In a case where the locking plate is located at the second position, the pin shaft is located in the unlocking hole, and the unlocking portion is located at the end where the first clamp body is rotatably connected to the second clamp body. The outer diameter of the locking portion and the outer diameter of the unlocking portion are set correspondingly, so that when the locking portion of the locking plate is located at the end where the first clamp body is rotatably connected to the second clamp body, a rotational limit for the first clamp body and the second clamp body is formed, and thus the first clamp body and the second clamp body are kept in a closed and locked state; and when the unlocking portion of the locking plate is located at the end where the first clamp body is rotatably connected to the second clamp body, a rotational limit for the first clamp body and the second clamp body can be released, thereby allowing the stem remover to open and close normally. The provision of the locking hole and the unlocking hole enables the locking plate to move relative to the pin shaft, thereby changing the position of the locking plate. The locking plate is made of a flexible material and may be an elastic body with a slight deformation capacity. In one or more embodiments, an outer diameter of the pin shaft may be slightly greater than that of each of the locking hole and the unlocking hole, so that the pin shaft forms an interference fit with the locking hole or the unlocking hole. In this case, the stem remover can be prevented from switching between the locked state and the unlocked state in the case of accidental contact.

Further, the unlocking portion has an arc-shaped structure. The outer diameter of the unlocking portion with the arc-shaped structure changes from large to small, which can not only provide an avoidance space for the rotation of the first clamp body and the second clamp body, but also can abut and rotate around the arc-shaped structure when the first clamp body and the second clamp body rotate relatively. Moreover, a certain limit is formed for the rotation angle between the two clamp bodies, so that the first clamp body and the second clamp body may be opened relatively without interference.

Further, the movable hole further includes a limit hole, an end of the limit hole communicates with the locking hole, another end of the limit hole communicates with the unlocking hole, a bore diameter of the limit hole is less than a bore diameter of the locking hole, and the bore diameter of the limit hole is less than a bore diameter of the unlocking hole. The outer diameter of the pin shaft may be slightly less than that of each of the locking hole and the unlocking hole, but greater than that of the limit hole. The pin shaft is in a clearance fit with the locking hole or the unlocking hole, and the limit hole is used for movement limitation. The limit hole serves as a connection transition between the locking hole and the unlocking hole, so that the stem remover will not change its state due to accidental contact when it is in the locked or unlocked state, which not only ensures normal use but also enhances safety.

Further, the locking plate is further provided with an avoidance hole penetrating through the locking plate, and the avoidance hole is located beside the movable hole. The avoidance hole is provided to facilitate the movement of the locking plate relative to the pin shaft in the locking hole or the unlocking hole, thereby enabling the stem remover to switch between the locked state and the unlocked state.

Further, two avoidance holes are provided, and the two avoidance holes are located on two sides of the movable hole, respectively. The avoidance hole is obtained by hollowing out the locking plate. The avoidance hole is provided to facilitate the switching of the locking plate between the first position and the second position.

Further, the locking plate further includes a first pushing portion and a second pushing portion. The first pushing portion is located at an end of the locking portion facing away from the unlocking portion, the second pushing portion is mounted on the unlocking portion, and the movable hole is located in the locking portion. The first pushing portion is provided to facilitate movement of the locking plate from the second position to the first position, thereby switching the stem remover from the unlocked state to the locked state. The second pushing portion is provided to facilitate movement of the locking plate from the first position to the second position, thereby facilitating switching of the stem remover from the locked state to the unlocked state. Due to the relatively large outer diameter of the locking portion, the locking portion has ample internal space, which facilitates disposing of the movable hole in the locking portion.

Further, the locking plate further includes a first pushing portion and a second pushing portion. The first pushing portion, the locking portion, the unlocking portion, and the second pushing portion are sequentially connected. The movable hole is located in the locking portion. The first pushing portion is an extension of the locking portion in a direction facing away from the unlocking portion, and the second pushing portion is an extension of the unlocking portion in a direction facing away from the locking portion. The provision of the first pushing portion and the second pushing portion may facilitate movement of the locking plate.

Further, the first pushing portion and/or the second pushing portion are provided with an anti-slip pattern. The anti-slip texture can improve the anti-slip effect and facilitate the movement of the locking plate.

Further, an outer diameter of the pin shaft in the first direction is greater than an outer diameter of the pin shaft in the second direction, each of the bore diameter of the locking hole and the bore diameter of the unlocking hole is greater than the outer diameter of the pin shaft in the first direction, and the bore diameter of the limit hole is less than the outer diameter of the pin shaft in the first direction and is greater than the outer diameter of the pin shaft in the second direction. The outer diameter of the pin shaft is set so that when the locking plate is made of a rigid material that cannot deform, the direction of the pin shaft can be changed by rotating the pin shaft. This allows the pin shaft to move from the unlocking hole via the limit hole into the locking hole, or to move from the locking hole via the limit hole into the unlocking hole. In fact, the pin shaft can only rotate, while its position remains unchanged. Therefore, the shift of the above-described pin shaft between the locking hole and the unlocking hole is actually a change in the position of the locking plate. The locking plate may be pushed to move only by rotating the pin shaft, thereby enabling the stem remover to switch between the locked state and the unlocked state.

Further, the locking structure is slidably connected to each of the first clamp body and the second clamp body. The first clamp body and the second clamp body are locked by the locking structure, so that the first clamp body and the second clamp body may be maintained in the locked state when closed. When unlocking is needed, the locking structure may be disengaged from the first clamp body and/or the second clamp body to release the rotation limit between the first clamp body and the second clamp body, thereby acting as the unlocking function.

Further, the first clamp body or the second clamp body is provided with a limit block for preventing the locking structure from disengaging. In one or more embodiments, two limit blocks are provided, the two limit blocks are respectively disposed at upper and lower limit positions, where the locking structure slides, on the first clamp body, so that when the locking structure slides relative to the first clamp body, the connection with the first clamp body is always maintained to avoid sliding out of and disengaging from the first clamp body. When locked, the locking structure is slidingly connected to the second clamp body; when unlocked, the locking structure is disengaged from the second clamp body, to release the rotational limit between the first clamp body and the second clamp body. The first clip body and the second clip body are not specifically limited and may refer to either side of the stem remover. Further, the locking structure is rotatably connected to the first clamp body and is snapped with the second clamp body. The locking structure is mounted on the first clamp body and is rotatably connected to the first clamp body. When locked, the locking structure is snapped with the second clamp body to achieve the rotation limit for the first clamp body and the second clamp body. When unlocked, the locking structure is disengaged from the second clamp body, and the rotational limit between the first clamp body and the second clamp body can be released. The first clip body and the second clip body are not specifically limited and may refer to either side of the stem remover.

The present application has the following beneficial effects. Based on the stem-removing function, the stem remover of the present application is additionally provided with the locking function for the closed state. This allows users to store it safely when not in use, saves storage space, protects the blade to extend its service life, and also ensures the safety of users.

### BRIEF DESCRIPTION OF DRAWINGS

FIG. 1 is a structural diagram of an unlocked and open state according to an embodiment 1 of the present application.

FIG. 2 is a structural view of FIG. 1 cut from the middle.

FIG. 3 is a structural diagram of a locked and closed state according to an embodiment 1 of the present application.

FIG. 4 is a structural view of FIG. 3 cut from the middle.

FIG. 5 is a structural diagram of a locking plate according to an embodiment 1 of the present application.

FIG. 6 is a structural diagram of a pin shaft according to an embodiment 3 of the present application.

FIG. 7 is a structural diagram of a locking plate in a locked state according to an embodiment 3 of the present application.

FIG. 8 is a structural diagram of a locking plate in the process of switching between a locked state and an unlocked state according to an embodiment 3 of the present application.

FIG. 9 is a structural diagram of an unlocked and open state according to an embodiment 4 of the present application.

FIG. 10 is a structural diagram of a locked and closed state according to an embodiment 4 of the present application.

FIG. 11 is a structural diagram of an unlocked and open state according to an embodiment 5 of the present application.

FIG. 12 is a structural diagram of a locked and closed state according to an embodiment 5 of the present application.

### LIST OF REFERENCE NUMBERS

1 first clamp body
11 first handle
12 first blade
2 second clamp body
21 second handle
22 second blade
3 pin shaft
4 locking plate
41 locking portion
42 unlocking portion
43 first pushing portion
44 second pushing portion
5 torsion spring
61 locking hole
62 limit hole
63 unlocking hole
64 avoidance hole
7 locking structure

### DETAILED DESCRIPTION

The accompanying drawings are for illustrative purposes only and shall not be construed as limiting the present patent. In order to better explain this embodiment, some components in the accompanying drawings may be omitted, enlarged, or reduced, which do not represent the dimensions of the actual product. It is to be understood by those skilled in the art that some well-known structures in the accompanying drawings and their descriptions may be omitted. The positional relationships described in the accompanying drawings are for illustrative purposes only and shall not be construed as limiting the present patent.

In the accompanying drawings of embodiments of the present application, the same or similar reference numerals correspond to the same or similar components. In the description of the present application, it is to be understood that if orientations or position relations indicated by terms such as “upper”, “lower”, “left”, “right”, “long”, “short” are based on orientations or position relations shown in the accompanying drawings. These orientations or position relations are intended merely to facilitate and simplify the description of the present application and not to indicate or imply that a device or element referred to must have such particular orientations or must be configured or operated in such particular orientations. Therefore, the terms for describing positional relationships in the accompanying drawings are only for illustrative purposes and shall not be construed as limiting the present patent. For those of ordinary skill in the art, the specific meanings of the above terms may be understood according to specific circumstances.

The technical solutions of the present application will be further described in detail below through specific embodiments and in conjunction with the accompanying drawings.

### Embodiment 1

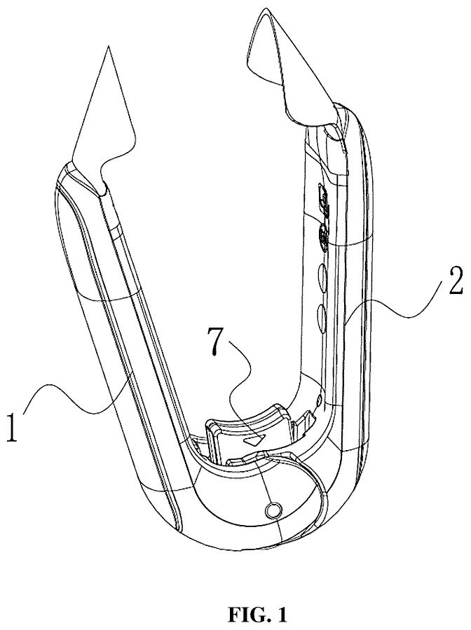

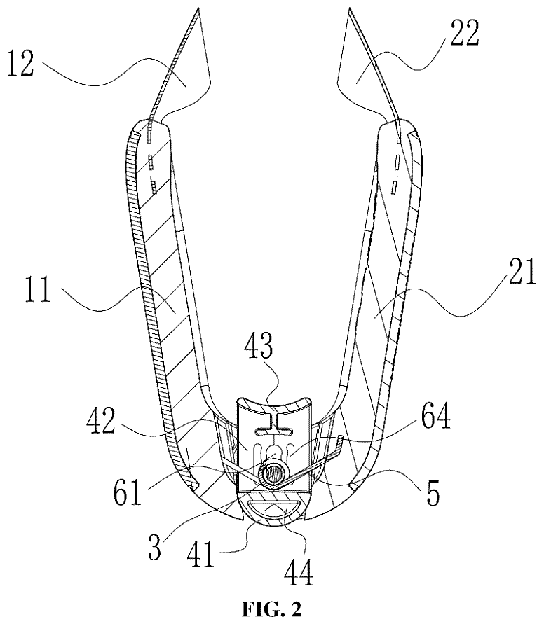

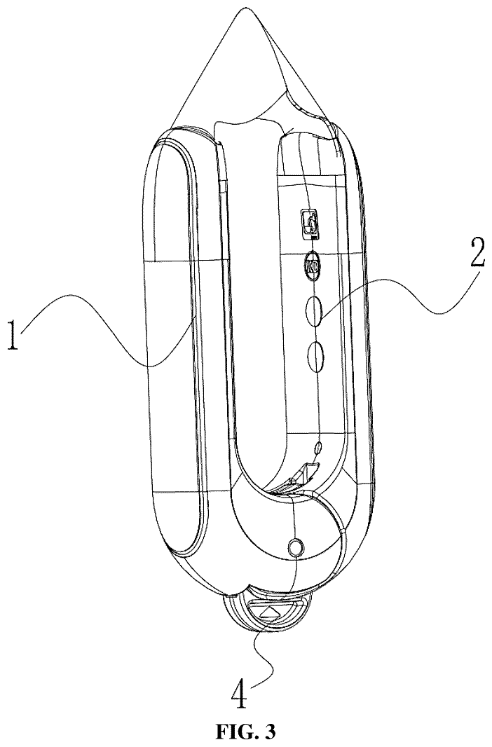

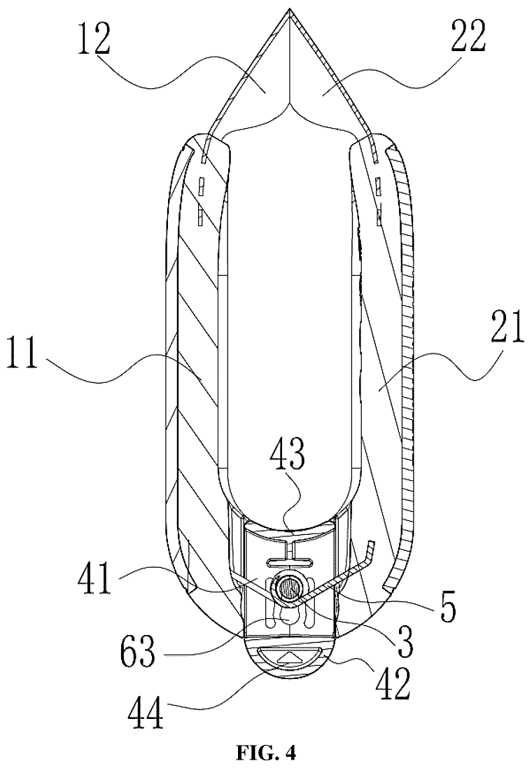

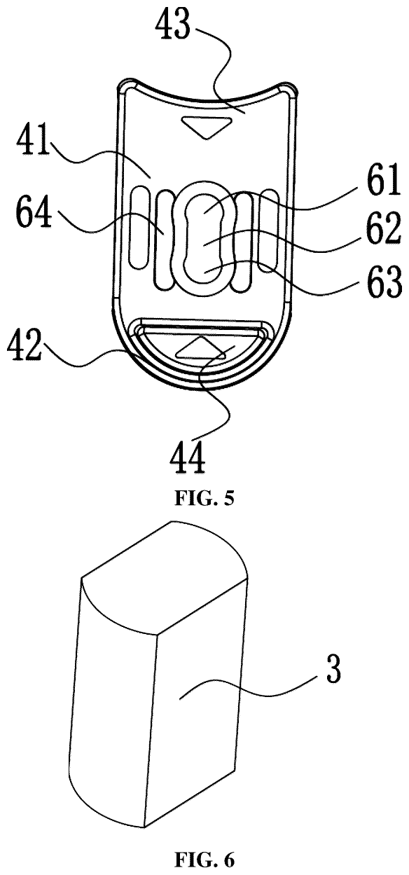

As shown in FIGS. 1 to 5, an embodiment 1 of a stem remover of the present application is provided. The stem remover includes a first clamp body 1, a second clamp body 2 and a pin shaft 3. The first clamp body 1 is rotatably connected to the second clamp body 2 through the pin shaft 3. The stem remover further includes a locking structure 7, and the locking structure 7 is movably mounted at an end where the first clamp body 1 and/or the second clamp body 2 are rotatably connected.

The stem remover in the present application achieves the stem-removing function in a manner of clamping the root and stem parts of fruits and vegetables by using the end of the first clamp body 1 and the end of the second clamp body 2, and then pulling them out. The first clamp body 1 is rotatably connected to the second clamp body 2 through the pin shaft 3, thereby facilitating the adjustment of the distance between the two clamp bodies, and thus facilitating stem removal after an acting force is exerted on the root and stem. Compared with the stem remover in the related art, the stem remover of the present application adds a function of locking when the stem remover is in a closed state, which is achieved specifically through the locking structure 7. The locking structure 7 may be a switch mounted at the end where the first clamp body 1 is rotatably connected to the second clamp body 2. When locked, the first clamp body 1 and the second clamp body 2 cannot be opened, so the first clamp body 1 and the second clamp body 2 may be maintained in a locked state when closed. When unlocked, the first clamp body 1 and the second clamp body 2 may be freely opened or closed. The locking structure 7 can also achieve the locking and unlocking functions of the first clamp body 1 and the second clamp body 2 in other manners.

As an improved solution of this embodiment, the first clip body 1 includes a first handle 11 and a first blade 12. The second clip body 2 includes a second handle 21 and a second blade 22. The first handle 11 is rotatably connected to the second handle 21 through the pin shaft 3. The first blade 12 is mounted at an end of the first handle 11 facing away from the pin shaft 3, and the second blade 12 is mounted at an end of the second handle 21 facing away from the pin shaft 3. The first handle 11 and the second handle 21 are made to move close to or away from each other, so that the first blade 12 and the second blade 22 are moved close to or away from each other, thereby enabling the clamping and releasing functions of the stem remover. The first blade 12 and the second blade 22 act synergistically on the root and stem of vegetables and fruits to perform the stem removal operation.

In one or more embodiments, the locking structure 7 includes a locking plate 4 and a torsion spring 5. The torsion spring 5 is sleeved on the pin shaft 3, and two ends of the torsion spring 5 are contacted to opposite inner sides of the first clamp body 1 and the second clamp body 2, respectively. The locking plate 4 is located between the first clamp body 1 and the second clamp body 2 and is provided with a movable hole penetrating through the locking plate 4. The pin shaft 3 is located in the movable hole, two ends of the pin shaft 3 are disposed to protrude beyond the locking plate 4, and the locking plate 4 is movable back and forth relative to the pin shaft 3. In a locked state, the torsion spring 5 is compressed, the locking plate 4 is located at a first position and forms a rotation limit for the first clamp body 1 and the second clamp body 2, and the first clamp body 1 and the second clamp body 2 are kept closed. In an unlocked state, the locking plate 4 is located at a second position, and the torsion spring 5 is capable of pushing the first clamp body 1 and the second clamp body 2 to open outwards.

The cooperation between the locking plate 4 and the torsion spring 5 enables the locking or unlocking of the first clamp body 1 and the second clamp body 2. In one or more embodiments, the torsion spring 5 is mounted on the pin shaft 3. When the stem remover is in the closed state, that is, the first clamp body 1 and the second clamp body 2 are closed, the torsion spring 5 is in a stressed and compressed state. In this case, if the locking plate 4 is located at the first position, since the first clamp body 1 and the second clamp body 2 are limited by the locking plate 4 and no rotation space exists, then the stem remover is locked, and the first clamp body 1 and the second clamp body 2 are kept closed. Instead, if the locking plate 4 is located at the second position, an avoidance is formed for rotating ends of the first clamp body 1 and the second clamp body 2, and a rotatable space exists between the first clamp body 1 and the second clamp body 2, then under the drive of the elastic restoring force of the torsion spring 5, the first clamp body 1 and the second clamp body 2 move away from each other, the stem remover is opened, and thus a normal stem removal operation may be performed. Since the position of the pin shaft 3 remains fixed, the stem remover pushes the locking plate 4 to move the movable hole relative to the pin shaft 3, thereby changing the position of the locking plate 4 relative to the pin shaft 3. This enables an end where the first clamp body is rotatably connected to the second clamp body to be either limited or provided with a rotation space, thereby allowing the stem remover to flexibly switch between the locked state and the unlocked state. The stem remover is locked in the closed state when not in use, which can not only improve the safety factor but also save storage space and enhance the convenience of storage.

In one or more embodiments, the locking plate 4 includes a locking portion 41 and an unlocking portion 42 connected to each other, an outer diameter of the locking portion 41 is greater than an outer diameter of the unlocking portion 42, and the movable hole is located in the locking portion 41 and/or the unlocking portion 42 and includes a locking hole 61 and an unlocking hole 63 communicating with each other. When the locking plate 4 is located at the first position, the pin shaft 3 is located in the locking hole 61, and the locking portion 41 is located at the end where the first clamp body 1 is rotatably connected to the second clamp body 2. When the locking plate 4 is located at the second position, the pin shaft 3 is located in the unlocking hole 63, and the unlocking portion 42 is located at the end where the first clamp body 1 is rotatably connected to the second clamp body 2.

The outer diameter of the locking portion 41 and the outer diameter of the unlocking portion 42 are set correspondingly, so that when the locking portion 41 of the locking plate 4 is located at the end where the first clamp body 1 is rotatably connected to the second clamp body 2, a rotational limit for the first clamp body 1 and the second clamp body 2 is formed, and thus the first clamp body 1 and the second clamp body 2 are kept in a closed and locked state; and when the unlocking portion 42 of the locking plate 4 is located at the end where the first clamp body 1 is rotatably connected to the second clamp body 2, a rotational limit for the first clamp body 1 and the second clamp body 2 can be released, thereby allowing the stem remover to open and close normally. The provision of the locking hole 61 and the unlocking hole 63 enables the locking plate 4 to move relative to the pin shaft 3, thereby changing the position of the locking plate 4. The locking plate 4 is made of a flexible material and may be an elastic body with a slight deformation capacity. In one or more embodiments, an outer diameter of the pin shaft 3 may be slightly greater than that of each of the locking hole 61 and the unlocking hole 63, so that the pin shaft 3 forms an interference fit with the locking hole 61 or the unlocking hole 63. In this case, the stem remover can be prevented from switching between the locked state and the unlocked state in the case of accidental contact.

In one or more embodiments, the unlocking portion 42 has an arc-shaped structure. The outer diameter of the unlocking portion 42 with the arc-shaped structure changes from large to small, which can not only provide an avoidance space for the rotation of the first clamp body 1 and the second clamp body 2, but also can abut against and rotate around the arc-shaped structure when the first clamp body 1 and the second clamp body 2 rotate relatively. Moreover, a certain limit is formed for the rotation angle between the two clamp bodies, so that the first clamp body 1 and the second clamp body 2 may be opened relatively without interference.

The movable hole further includes a limit hole 62, one end of the limit hole 62 communicates with the locking hole 61, another end of the limit hole 62 communicates with the unlocking hole 63, a bore diameter of the limit hole 62 is less than a bore diameter of the locking hole 61, and the bore diameter of the limit hole 62 is less than a bore diameter of the unlocking hole 63. The outer diameter of the pin shaft 3 may be slightly less than that of each of the locking hole 61 and the unlocking hole 63, but greater than that of the limit hole 62. The pin shaft 3 is in a clearance fit with the locking hole 61 or the unlocking hole 63, and the limit hole 62 is used for movement limitation. The limit hole 62 serves as a connection transition between the locking hole 61 and the unlocking hole 63, so that the stem remover will not change its state due to accidental contact when it is in the locked or unlocked state, which not only ensures normal use but also enhances safety.

As an improved solution of this embodiment, the locking plate 4 is further provided with an avoidance hole 64 penetrating through the locking plate 4, and the avoidance hole 64 is located beside the movable hole. The avoidance hole 64 is provided to facilitate the movement of the locking plate 4 relative to the pin shaft 3 in the locking hole 61 or the unlocking hole 63, thereby enabling the stem remover to switch between the locked state and the unlocked state.

Further, two avoidance holes 64 are provided, and the two avoidance holes 64 are located on two sides of the movable hole, respectively. The avoidance hole 64 is obtained by hollowing out the locking plate 4. The avoidance hole 64 is provided to facilitate the switching of the locking plate 4 between the first position and the second position.

As an improved solution of this embodiment, the locking plate 4 further includes a first pushing portion 43 and a second pushing portion 44, the first pushing portion 43 is located at an end of the locking portion 41 facing away from the unlocking portion 42, the second pushing portion 44 is mounted on the unlocking portion 42, and the movable hole is located in the locking portion 41. The first pushing portion 43 is provided to facilitate movement of the locking plate 4 from the second position to the first position, thereby switching the stem remover from the unlocked state to the locked state. The second pushing portion 44 is provided to facilitate movement of the locking plate 4 from the first position to the second position, thereby facilitating switching of the stem remover from the locked state to the unlocked state. Due to the relatively large outer diameter of the locking portion 41, the locking portion 41 has ample internal space, which facilitates disposing of the movable hole in the locking portion 41. The second pushing portion 44 is recessedly disposed on the unlocking part 42, and the recess edge is used for limiting. When a force is applied to the second pushing portion 44, the locking plate 4 can be relatively easily moved from the first position to the second position.

Further, both the first pushing portion 43 and the second pushing portion 44 are provided with indicator marks. The indicator mark is used to indicate the moving direction of the locking plate 4. In one or more embodiments, the indicator mark on the first pushing portion 43 is a triangular arrow facing the unlocking portion 42, the indicator mark on the second pushing portion 44 is a triangular arrow facing the locking portion 41, and the two indicator marks are disposed opposite to each other.

In one or more embodiments, the first pushing portion 43 and/or the second pushing portion 44 are provided with an anti-slip pattern. The anti-slip texture can improve the anti-slip effect and facilitate the movement of the locking plate 4.

### Embodiment 2

This embodiment is an embodiment 2 of a stem remover, and this embodiment is similar to the embodiment 1, except that the locking plate 4 further includes a first pushing portion 43 and a second pushing portion 44. The first pushing portion 43, the locking portion 41, the unlocking portion 42, and the second pushing portion 44 are sequentially connected. The movable hole is located in the locking portion 41. The first pushing portion 43 is an extension of the locking portion 41 in a direction facing away from the unlocking portion 42, and the second pushing portion 44 is an extension of the unlocking portion 42 in a direction facing away from the locking portion 41, and the provision of the first pushing portion 43 and the second pushing portion 44 may facilitate movement of the locking plate 4.

### Embodiment 3

This embodiment is an embodiment 3 of a stem remover, and this embodiment is similar to the embodiment 1, except that, as shown in FIG. 6, an outer diameter of the pin shaft 3 in the first direction is greater than an outer diameter of the pin shaft 3 in the second direction, each of the bore diameter of the locking hole 61 and the bore diameter of the unlocking hole 63 is greater than the outer diameter of the pin shaft 3 in the first direction, and the bore diameter of the limit hole 62 is less than the outer diameter of the pin shaft 3 in the first direction and is greater than the outer diameter of the pin shaft 3 in the second direction.

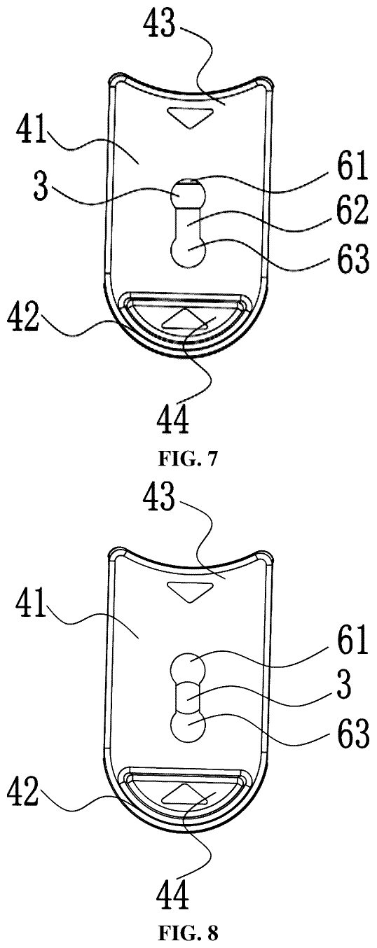

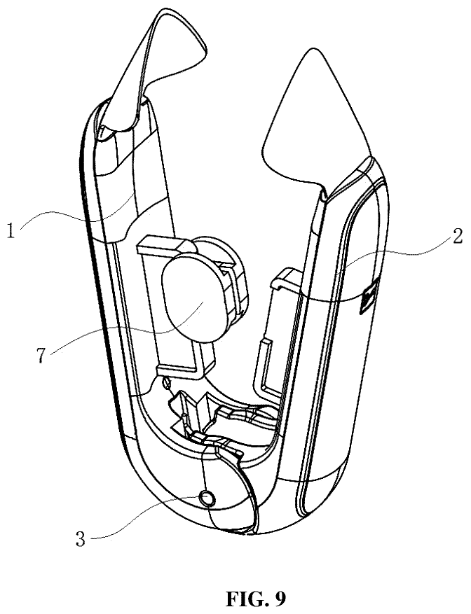

The outer diameter of the pin shaft 3 is set so that when the locking plate 4 is made of a rigid material that cannot deform, the direction of the pin shaft 3 can be changed by rotating the pin shaft 3. This allows the pin shaft 3 to move from the unlocking hole 63 via the limit hole 62 into the locking hole 61, or to move from the locking hole 61 via the limit hole 62 into the unlocking hole 63. In fact, the pin shaft 3 can only rotate, while its position remains unchanged. Therefore, as shown in FIGS. 7 and 8, the shift of the above-described pin shaft 3 between the locking hole 61 and the unlocking hole 63 is actually a change in the position of the locking plate 4. The locking plate 4 may be pushed to move only by rotating the pin shaft 3, thereby enabling the stem remover to switch between the locked state and the unlocked state.

As an improved solution of this embodiment, two ends of the pin shaft 3 are disposed to protrude beyond the first clamp body 1 and the second clamp body 2. A gripping force-applying portion is disposed on the pin shaft 3. In one or more embodiments, the force-applying portion is a protrusion or a groove. The provision of the force-applying portion facilitates manual rotation of the pin shaft 3, thereby enabling the pin shaft 3 to flexibly switch between a horizontal state in the first direction and a horizontal state in the second direction, so as to facilitate the locking and unlocking of the locking plate 4.

### Embodiment 4

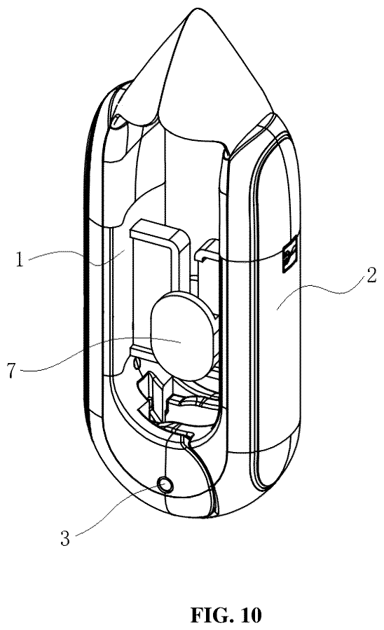

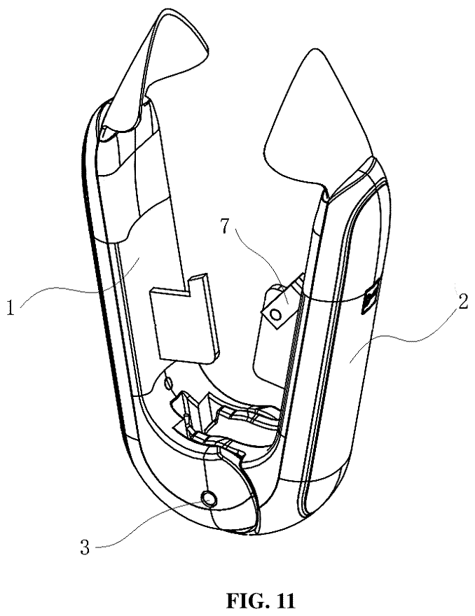

As shown in FIGS. 9 and 10, this embodiment is an embodiment 4 of a stem remover, and this embodiment is similar to the embodiment 1, except that the locking structure 7 is slidably connected to each of the first clamp body 1 and the second clamp body 2. In one or more embodiments, the locking structure 7 is located on opposite inner sides of the first clamp body 1 and the second clamp body 2. The first clamp body 1 and the second clamp body 2 are locked by using the locking structure 7, so that the first clamp body 1 and the second clamp body 2 may be maintained in the locked state when closed. When unlocking is needed, the locking structure 7 may be disengaged from the first clamp body 1 and/or the second clamp body 2 to release the rotation limit between the first clamp body 1 and the second clamp body 2, thereby acting as the unlocking function.

Further, the first clamp body 1 or the second clamp body 2 is provided with a limit block for preventing the locking structure 7 from disengaging. In one or more embodiments, two limit blocks are provided, the two limit blocks are respectively disposed at upper and lower limit positions, where the locking structure 7 slides, on the first clamp body 1, so that when the locking structure 7 slides relative to the first clamp body 1, the connection with the first clamp body 1 is always maintained to avoid sliding out of and disengaging from the first clamp body 1. When locked, the locking structure 7 is slidingly connected to the second clamp body 2; when unlocked, the locking structure 7 is disengaged from the second clamp body 2, to release the rotational limit between the first clamp body 1 and the second clamp body 2. The first clip body 1 and the second clip body 2 are not specifically limited and may refer to either side of the stem remover.

### Embodiment 5

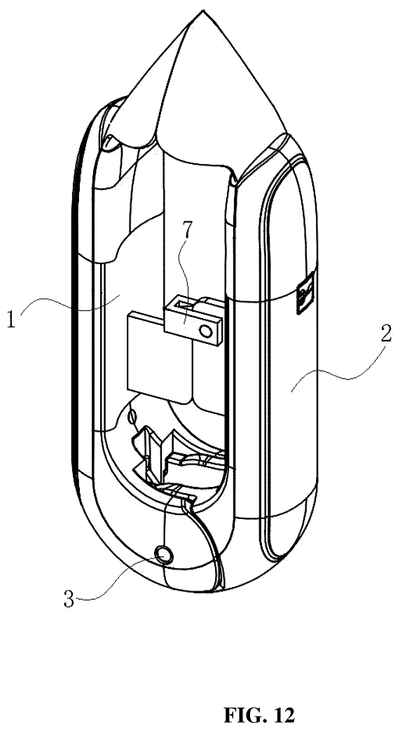

As shown in FIGS. 11 and 12, this embodiment is an embodiment 5 of a stem remover, and this embodiment is similar to the embodiment 1, except that the locking structure 7 is rotatably connected to the first clamp body 1 and is movably snapped with the second clamp body 2. In one or more embodiments, the locking structure 7 is located on opposite inner sides of the first clamp body 1 and the second clamp body 2. The locking structure 7 is mounted on the first clamp body 1 and is rotatably connected to the first clamp body 1. When locked, the locking structure 7 is snapped with the second clamp body 2 to achieve the rotation limit for the first clamp body 1 and the second clamp body 2. When unlocked, the locking structure 7 is disengaged from the second clamp body 2, and the rotational limit between the first clamp body 1 and the second clamp body 2 can be released. The first clip body 1 and the second clip body 2 are not specifically limited and may refer to either side of the stem remover.

Apparently, the above-described embodiments of the present application are merely examples for clearly illustrating the present application and are not intended to limit the embodiments of the present application. Other variations or modifications in different forms may be made in light of the above description for those of ordinary skill in the art. This need not be, nor should it be exhaustive of all embodiments. Any modifications, equivalents or improvements made within the spirit and principle of the present application should be included within the scope of protection of the claims of the present application.

What is claimed is:

1. A stem remover, comprising a first clamp body, a second clamp body and a pin shaft, the first clamp body being rotatably connected to the second clamp body through the pin shaft, wherein the stem remover further comprises a locking structure, and the locking structure is movably mounted on at least one of the first clamp body or the second clamp body.

2. The stem remover of claim 1, wherein the locking structure comprises a locking plate and a torsion spring, the torsion spring is sleeved on the pin shaft, two ends of the torsion spring abut against opposite inner sides of the first clamp body and the second clamp body, respectively, the locking plate is located between the first clamp body and the second clamp body and is provided with a movable hole penetrating through the locking plate, the pin shaft is located in the movable hole, two ends of the pin shaft are disposed to protrude beyond the locking plate, and the locking plate is movable back and forth relative to the pin shaft; in a locked state, the torsion spring is compressed, the locking plate is located at a first position and forms a rotation limit for the first clamp body and the second clamp body, and the first clamp body and the second clamp body are kept closed; in an unlocked state, the locking plate is located at a second position, and the torsion spring is capable of pushing the first clamp body and the second clamp body to open outwards.

3. The stem remover of claim 2, wherein the locking plate comprises a locking portion and an unlocking portion connected to each other, an outer diameter of the locking portion is greater than an outer diameter of the unlocking portion, and the movable hole is located in at least one of the locking portion or the unlocking portion and comprises a locking hole and an unlocking hole communicating with each other; in a case where the locking plate is located at the first position, the pin shaft is located in the locking hole, and the locking portion is located at an end where the first clamp body is rotatably connected to the second clamp body; in a case where the locking plate is located at the second position, the pin shaft is located in the unlocking hole, and the unlocking portion is located at the end where the first clamp body is rotatably connected to the second clamp body.

4. The stem remover of claim 2, wherein the movable hole further comprises a limit hole, an end of the limit hole communicates with the locking hole, an other end of the limit hole communicates with the unlocking hole, a bore diameter of the limit hole is less than a bore diameter of the locking hole, and the bore diameter of the limit hole is less than a bore diameter of the unlocking hole.

5. The stem remover of claim 4, wherein the locking plate is further provided with an avoidance hole penetrating through the locking plate, and the avoidance hole is located beside the movable hole.

6. The stem remover of claim 5, wherein the locking plate further comprises a first pushing portion and a second pushing portion, the movable hole is located in the locking portion, the first pushing portion is located at an end of the locking portion facing away from the unlocking portion, and the second pushing portion is mounted on the unlocking portion or is located at an end of the unlocking portion facing away from the locking portion.

7. The stem remover of claim 4, wherein an outer diameter of the pin shaft in the first direction is greater than an outer diameter of the pin shaft in the second direction, each of a bore diameter of the locking hole and a bore diameter of the unlocking hole is greater than the outer diameter of the pin shaft in the first direction, and the bore diameter of the limit hole is less than the outer diameter of the pin shaft in the first direction and greater than the outer diameter of the pin shaft in the second direction.

8. The stem remover of claim 1, wherein the locking structure is slidably connected to each of the first clamp body and the second clamp body.

9. The stem remover of claim 8, wherein a limit block for preventing the locking structure from disengagement is disposed on the first clamp body or the second clamp body.

10. The stem remover of claim 1, wherein the locking structure is rotatably connected to the first clamp body and is movably snapped with the second clamp body.

11. The stem remover of claim 3, wherein the movable hole further comprises a limit hole, an end of the limit hole communicates with the locking hole, an other end of the limit hole communicates with the unlocking hole, a bore diameter of the limit hole is less than a bore diameter of the locking hole, and the bore diameter of the limit hole is less than a bore diameter of the unlocking hole.

12. The stem remover of claim 11, wherein the locking plate is further provided with an avoidance hole penetrating through the locking plate, and the avoidance hole is located beside the movable hole.

13. The stem remover of claim 11, wherein an outer diameter of the pin shaft in the first direction is greater than an outer diameter of the pin shaft in the second direction, each of a bore diameter of the locking hole and a bore diameter of the unlocking hole is greater than the outer diameter of the pin shaft in the first direction, and the bore diameter of the limit hole is less than the outer diameter of the pin shaft in the first direction and greater than the outer diameter of the pin shaft in the second direction.
